(19) United States
(12) Patent Application Publication
(10) Pub. No.: US 2025/0328042 A1
(43) Pub. Date: Oct. 23, 2025

(54) ELECTRONIC DEVICE

(71) Applicant: InnoLux Corporation, Miao-Li County (TW)

(72) Inventors: Hsu-Kuan HSU, Miao-Li County (TW); Chih-Chin KUO, Miao-Li County (TW)

(21) Appl. No.: 19/086,501

(22) Filed: Mar. 21, 2025

(30) Foreign Application Priority Data
Apr. 22, 2024 (CN) 202410483073.4

(51) Int. Cl. G02F 1/1335; G02F 1/1333; G02F 1/1337; G02F 1/1343; G02F 1/137

(52) U.S. Cl. CPC G02F 1/133504; G02F 1/133368; G02F 1/133502; G02F 1/1337; G02F 1/134363; G02F 1/13718; G02F 1/13775

(57) ABSTRACT

An electronic device includes: a light scattering switching element including: a first substrate; a second substrate; a first light modulation layer disposed between the first and second substrates and including a positive cholesteric liquid crystal; a first alignment layer disposed between the first substrate and the first light modulation layer and vertically aligned; a second alignment layer disposed between the second substrate and the first light modulation layer and vertically aligned; a first electrode layer disposed between the first substrate and the first alignment layer; and a second electrode layer disposed between the second substrate and the second alignment layer, wherein the light scattering switching element is in a hazing state under an initial state, wherein when voltage is respectively applied to the first and second electrode layers to generate a vertical electric field, the light scattering switching element is in a transmitting state.

### CROSS-REFERENCE TO RELATED APPLICATIONS

This application claims the benefits of the Chinese Patent Application Serial Number 202410483073.4, filed on Apr. 22, 2024, the subject matter of which is incorporated herein by reference.

### BACKGROUND

### Field

The present disclosure is relates to an electronic device and, more specifically, to an electronic device capable of switching between the transmitting state and the hazing state.

### Description of Related Art

Among the electronic devices on the market that can switch between the transmitting state and the hazing state, most of them use positive-type liquid crystals with horizontal alignment layers, and the electronic device can be switched between the transmitting state and the hazing state by controlling voltage.

However, the conventional electronic device still has defects such as insufficient transparency in the transmitting state, or poor light-shielding effect in the hazing state.

Therefore, it is desirable to provide an electronic device capable of switching between the transmitting state and the hazing state to solve the conventional defects.

### SUMMARY

The present disclosure provides an electronic device, comprising: a light scattering switching element, comprising: a first substrate; a second substrate disposed opposite to the first substrate; a first light modulation layer disposed between the first substrate and the second substrate, wherein the first light modulation layer comprises a positive cholesteric liquid crystal; a first alignment layer disposed between the first substrate and the first light modulation layer and vertically aligned; a second alignment layer disposed between the second substrate and the first light modulation layer and vertically aligned; a first electrode layer disposed between the first substrate and the first alignment layer; and a second electrode layer disposed between the second substrate and the second alignment layer, wherein the light scattering switching element is in a hazing state under an initial state, wherein when voltage is respectively applied to the first electrode layer and the second electrode layer to generate a vertical electric field between the first electrode layer and the second electrode layer, the light scattering switching element is in a transmitting state.

Other novel features of the disclosure will become more apparent from the following detailed description when taken in conjunction with the accompanying drawings.

### BRIEF DESCRIPTION OF DRAWINGS

FIG. 1A and FIG. 1B are schematic views of a light scattering switching element according to one embodiment of the present disclosure.

FIG. 1C is a partial enlarged view of FIG. 1B.

FIG. 1D is a schematic view showing the pretilt angle according to one embodiment of the present disclosure.

FIG. 2A and FIG. 2B are schematic views of a light scattering switching element according to one embodiment of the present disclosure.

FIG. 3A and FIG. 3B are schematic views of a light scattering switching element according to one embodiment of the present disclosure.

FIG. 4 is a schematic view showing a part of an electronic device according to one embodiment of the present disclosure.

FIG. 5A and FIG. 5B are schematic views of a light absorption switching element according to one embodiment of the present disclosure.

FIG. 6 is a schematic view showing a part of an electronic device according to one embodiment of the present disclosure.

FIG. 7A is a schematic view of a light scattering switching element according to one embodiment of the present disclosure.

FIG. 7B is a schematic view of a light absorption switching element according to one embodiment of the present disclosure.

FIG. 8A and FIG. 8B are schematic views showing an electronic device under a projection mode according to one embodiment of the present disclosure.

FIG. 9A is a schematic view showing a part of an electronic device according to one embodiment of the present disclosure.

FIG. 9B is a partial schematic view of FIG. 9A.

### DETAILED DESCRIPTION

The following disclosure provides many different embodiments or examples for implementing different elements in the provided display device. Specific examples of each component and its configuration are described below to simplify the embodiments of the present disclosure. Of course, these are only examples and are not intended to limit the present disclosure. For example, if it is mentioned in the description that a first element is formed on a second element, it may include an embodiment in which the first element and the second element are in direct contact, or another embodiment in which an additional element is formed between the first element and the second element, so that they are not in direct contact. In addition, embodiments of the present disclosure may repeat component symbols and/or characters in different examples. Such repetition is for the sake of brevity and clarity and is not intended to indicate the relationship between different embodiments and/or structures discussed.

It should be understood that relative terms, such as “lower” or “bottom” or “higher” or “top” may be used in the embodiments to describe the relative relationship of one element to another element illustrated in the drawings. It will be understood that if the device in the figures is turned upside down, elements described as being on the “lower” side would then be elements described as being on the “upper” side. The embodiments of the present disclosure can be understood together with the drawings, and the drawings of the present disclosure are also regarded as part of the disclosure description. It should be understood that the drawings of the present disclosure are not drawn to scale and, in fact, the dimensions of elements may be arbitrarily enlarged or reduced in order to clearly illustrate the features of the present disclosure.

One structure (or layer, component, or substrate) described in the present disclosure is located on/above another structure (or layer, component, or substrate). This may mean that the two structures are adjacent and directly connected, or the two structures are adjacent rather than directly connected. Indirect connection means that there is at least one intermediary structure (or intermediary layer, intermediary component, intermediary substrate, or intermediary spacer) between two structures. The lower surface of one structure is adjacent to or directly connected to the upper surface of the intermediary structure, and the upper surface of another structure is adjacent to or directly connected to the lower surface of the intermediary structure. The intermediary structure can be composed of a single-layer or multi-layer solid structure or a non-solid structure, and there is no limit. In the present disclosure, when a structure is disposed “on” another structure, it may mean that the structure is “directly” on the other structure, or that the structure is “indirectly” on the other structure, that is, at least one structure is also sandwiched between the structure and the other structure.

In addition, it should be understood that the ordinal numbers used in the description and the claims, such as “first”, “second”, etc., are intended only to describe the elements claimed and imply or represent neither that the (these) elements have any proceeding ordinals, nor that sequence between one claimed element and another claimed element or between steps of a manufacturing method. The use of these ordinals is merely to differentiate one claimed element having a certain designation from another claimed element having the same designation. The same words may not be used in the claim and the description. For example, the first element in the description may be the second element in the claim.

In some embodiments of the present disclosure, terms related to joining and connecting, such as “connection”, “interconnection”, etc., unless otherwise defined, may mean that two structures are in direct contact, or may also mean that two structures are not in direct contact where other structures are located between these two structures. The terms “joint” and “connection” can also include situations where both structures are movable, or where both structures are fixed. In addition, the terms “electrical connection” or “coupling” include any direct and indirect means of electrical connection.

The terms, such as “about”, “substantially”, or “approximately”, are generally interpreted as within 10%, 5%, 3%, 2%, 1%, or 0.5% of a given value or range. Unless otherwise stated, when a value is “in a range from a first value to a second value” or “in a range between a first value and a second value”, the value can be the first value, the second value, or another value between the first value and the second value. In addition, any two values or directions used for comparison may have certain errors. If the first value is equal to the second value, it implies that there may be an error of about 10% between the first value and the second value. If the first direction is perpendicular to the second direction, the angle between the first direction and the second direction may be between 80° and 100°. If the first direction is parallel to the second direction, the angle between the first direction and the second direction may be between 0° and 10°. In the present disclosure, the term “the given range is from the first value to the second value” and “the given range falls within the range of the first value to the second value” mean that the given range includes the first value, the second value and another value between the first value and the second value.

Furthermore, according to embodiments of the present disclosure, optical microscopy (OM), scanning electron microscope (SEM), film thickness profile measuring instrument (α-step), ellipsometer, or other suitable methods may be used to measure the thickness, length or width of each component or the distance and angle between components. Specifically, according to some embodiments, a scanning electron microscope can be used to obtain cross-sectional images of the structure and to measure the thickness, length, width, or distance and angle between components.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

It should be understood that the following embodiments can be replaced, reorganized, and combined with features of several different embodiments to complete other embodiments without departing from the spirit of the present disclosure. The features of various embodiments may be combined and used arbitrarily as long as they do not violate the spirit of the invention or conflict with each other.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those known in the art, the background of the present disclosure or the context of the present specification, and should not be read by an ideal or over-formal way. The present disclosure may be understood by referring to the following detailed description in conjunction with the accompanying drawings. It should be noted that, for the sake of ease of understanding for readers and simplicity of the drawings, many of the drawings in the present disclosure only depict a portion of an electronic device, and specific components in the drawings are not drawn according to actual scale. In addition, the number and size of each component in the figures are only for illustration and are not intended to limit the scope of the present disclosure.

The electronic device of the present disclosure may include electronic components, and the electronic components can include passive components, active components or a combination thereof, such as capacitors, resistors, inductors, varactor diodes, variable capacitors, filters, diodes, transistors, sensors, microelectromechanical system components (MEMS), liquid crystal chips, etc., but the present disclosure is not limited thereto. The diode may include light emitting diode or non-light emitting diode. The diode includes a P-N junction diode, a PIN diode or a constant current diode. The light emitting diode may include, for example, an organic light emitting diode (OLED), a mini LED, a micro LED, a quantum dot LED, fluorescence, phosphors, other suitable material or a combination thereof, but the present disclosure is not limited thereto. The sensor may include, for example, a capacitive sensor, an optical sensor, an electromagnetic sensor, a fingerprint sensor (FPS), a touch sensor, an antenna or a pen sensor, but the present disclosure is not limited thereto. In the following, the display device will be used as an electronic device to illustrate the content of the present disclosure, but the present disclosure is not limited thereto.

The electronic device may include an imaging device, a display device, a backlight device, an antenna device, a tiled device, a touch electronic device (a touch display), a curved electronic device (a curved display) or a non-rectangular electronic device (a free shape display), but the present disclosure is not limited thereto. The electronic device may include liquid crystals, light emitting diodes, fluorescence, phosphors, other suitable display media, or a combination thereof, but the present disclosure is not limited thereto. The display device may be a non-self-luminous display device or a self-luminous display device. The antenna device may be a liquid crystal antenna device or a non-liquid crystal antenna device. The sensing device may be a sensing device that can sense capacitance, light, heat energy or ultrasonic waves. But, the present disclosure is not limited thereto. It should be noted that the electronic device may be any permutation and combination of the above, but is not limited thereto. The electronic device may be a bendable or flexible electronic device. It should be noted that the electronic device may be any permutation and combination of the above, but not limited to this. In addition, the shape of the electronic device may be rectangular, circular, polygonal, or having a shape with curved edges or other suitable shapes. The electronic device may have peripheral systems such as drive systems, control systems, light source systems, shelf systems, etc. to support the display device, the antenna device or the tiled device. It should be noted that the following embodiments can be replaced, reorganized, and mixed with features in several different embodiments to complete other embodiments without departing from the spirit of the present disclosure. The features of various embodiments can be mixed and matched arbitrarily as long as they do not violate or conflict the spirit of the invention. It should be noted that the technical solutions provided in different embodiments below can be replaced, combined or mixed with each other to form another embodiment without violating the spirit of the present disclosure.

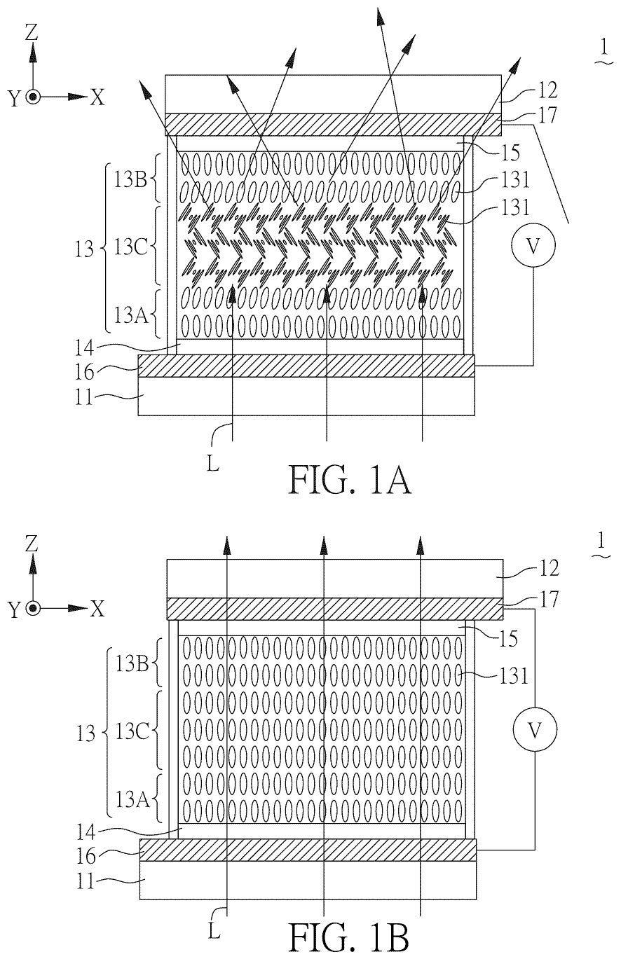

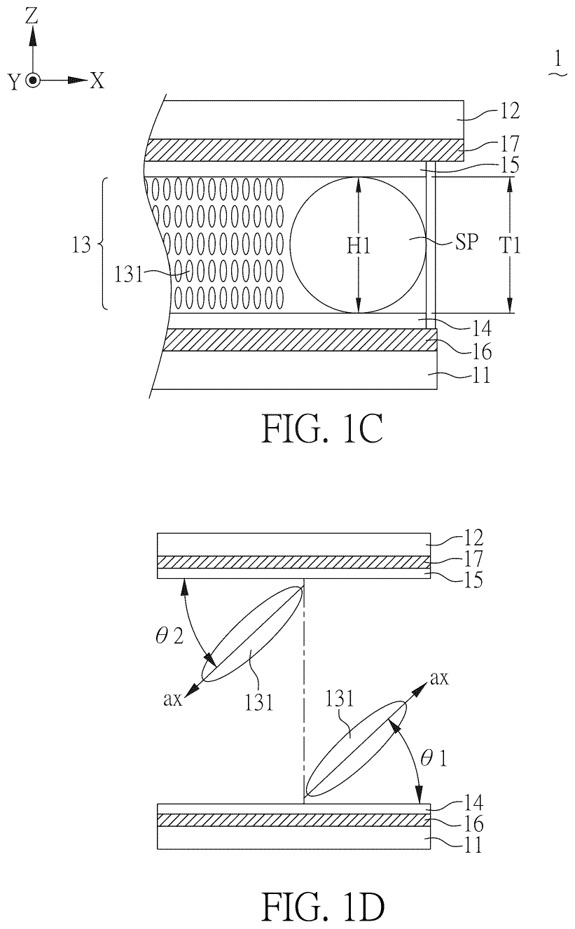

FIG. 1A and FIG. 1B are schematic views of a light scattering switching element according to one embodiment of the present disclosure. FIG. 1C is a partial enlarged view of FIG. 1B. FIG. 1D is a schematic view showing the pretilt angle according to one embodiment of the present disclosure.

In one embodiment of the present disclosure, as shown in FIG. 1A and FIG. 1B, the light scattering switching element 1 may comprise: a first substrate 11; a second substrate 12 disposed opposite to the first substrate 11; a first light modulation layer 13 disposed between the first substrate 11 and the second substrate 12; a first alignment layer 14 disposed between the first substrate 11 and the first light modulation layer 13; a second alignment layer 15 disposed between the second substrate 12 and the first light modulation layer 13; a first electrode layer 16 disposed between the first substrate 11 and the first alignment layer 14; and a second electrode layer 17 disposed between the second substrate 12 and the second alignment layer 15. As shown in FIG. 1A, the light scattering switching element 1 is in a hazing state under the initial state. As shown in FIG. 1B, when voltage is respectively applied to the first electrode layer 16 and the second electrode layer 17 to generate a vertical electric field between the first electrode layer 16 and the second electrode layer 17, the light scattering switching element 1 is in a transmitting state. The “initial state” may be, for example, the state without applying voltage or electric filed.

In the present disclosure, the first light modulation layer 13 may comprise a positive cholesteric liquid crystal 131. The first alignment layer 14 and the second alignment layer 15 may respectively be vertically aligned. Through the above design, the light scattering switching element 1 may be switched between the hazing state and the transmitting state. Thus, the haze of the light scattering switching element 1 in the hazing state can be improved, the light shielding effect can be improved, or the transmittance of the light scattering switching element 1 to light with wavelengths between 380 nm and 780 nm in the transmitting state can be improved.

When voltage is respectively applied to the first electrode layer 16 and the second electrode layer 17 to generate a vertical electric field between the first electrode layer 16 and the second electrode layer 17, the haze value of the light scattering switching element 1 may be between 0.5% and 20%, and the transmittance of the light scattering switching element 1 to light with wavelengths between 380 nm and 780 nm may be between 70% and 90%. By generating the vertical electric field between the first electrode layer 16 and the second electrode layer 17, the alignment of the (positive) cholesteric liquid crystal 131 in the first light modulation layer 13 can be controlled, so the light scattering switching element 1 can be switched between the hazing state and the transmitting state.

When the voltage is not respectively applied to the first electrode layer 16 and the second electrode layer 17, no (vertical) electric filed is generated between the first electrode layer 16 and the second electrode layer 17. As shown in FIG. 1A, the (positive) cholesteric liquid crystals 131 in the first light modulation layer 13 close to the first alignment layer 14 and/or the second alignment layer 15 may be affected by the vertical alignment and present a more regular arrangement. For example, the long axis direction of the cholesteric liquid crystal 131 may be approximately perpendicular to the first substrate 11 and the second substrate 12. The cholesteric liquid crystals 131 that are not affected by the first alignment layer 14 or the second alignment layer 15 may be, for example, arranged irregularly or in disorder. For example, most of the incident light L passes through the aforesaid arranged cholesteric liquid crystals 131 in the light scattering switching element 1, and the hazing state can be present. When voltage is respectively applied to the first electrode layer 16 and the second electrode layer 17 to generate a vertical electric field between the first electrode layer 16 and the second electrode layer 17, as shown in FIG. 1B, the cholesteric liquid crystals 131 in the first light modulation layer 13 may be affected by, for example, the vertical alignment and the vertical electric field to present a more regular arrangement. For example, the long axis direction of the cholesteric liquid crystal 131 is approximately perpendicular to the first substrate 11 and the second substrate 12. At this time, most of the incident light L may pass through the light scattering switching element 1, and the light scattering switching element 1 presents a more transparent transmitting state. More specifically, as shown in FIG. 1A and FIG. 1B, the first light modulation layer 13 may comprise, for example, a plurality of portions, for example, a first portion 13A, a second portion 13B and a third portion 13C, but the present disclosure is not limited thereto. The first portion 13A may be, for example, the portion close to the first alignment layer 14, the second portion 13B may be, for example, the portion close to the second alignment layer 15, and the third portion 13C may be, for example, located between the first portion 13A and the second portion 13B. In the normal directionof the first substrate 11 (for example, the Z direction), the thicknesses of the first portion 13A, the second portion 13B and the third portion 13C may be the same or different. When no voltage is respectively applied to the first electrode layer 16 and the second electrode layer 17, as shown in 1A, the cholesteric liquid crystals 131 in the first portion 13A of the first light modulation layer 13 may be, for example, affected by the vertical alignment of the first alignment layer 14 and approximately present in regular arrangement (for example, the long axis direction of the cholesteric liquid crystal 131 is perpendicular to the first substrate 11), the cholesteric liquid crystals 131 in the second portion 13B of the first light modulation layer 13 may be affected by the vertical alignment of the second alignment layer 15 and approximately present in regular arrangement (for example, the long axis direction of the cholesteric liquid crystal 131 is perpendicular to the second substrate 12), and the cholesteric liquid crystals 131 in the third portion 13C of the first light modulation layer 13 are not easily affected by the first alignment layer 14 or the second alignment layer 15 and present in irregular arrangement because they are far away from the first alignment layer 14 and the second alignment layer 15. Thus, most of the incident light L may be, for example, scattered by the cholesteric liquid crystals 131 in the third portion 13C of the first light modulation layer 13 after passing the third portion 13C, so that the light scattering switching element 1 is in the hazing state. When the voltage is respectively applied to the first electrode layer 16 and the second electrode layer 17 to generate a vertical electric field between the first electrode layer 16 and the second electrode layer 17, as shown in FIG. 1B, the cholesteric liquid crystals 131 in the first portion 13A of the first light modulation layer 13 may be affected by the first alignment layer 14 and the vertical electric field and approximately present in regular arrangement (for example, the long axis direction of the cholesteric liquid crystal 131 is perpendicular to the first substrate 11), the cholesteric liquid crystals 131 in the second portion 13B of the first light modulation layer 13 may be affected by the second alignment layer 15 and the vertical electric field and approximately present in regular arrangement (for example, the long axis direction of the cholesteric liquid crystal 131 is perpendicular to the second substrate 12), and the cholesteric liquid crystals 131 in the third portion 13C of the first light modulation layer 13 may be affected by the vertical electric field and approximately present in regular arrangement (for example, the long axis direction of the cholesteric liquid crystal 131 is perpendicular to the first substrate 11 or the second substrate 12). Thus, most of the incident light L may pass the first light modulation layer 13, and the light scattering switching element 1 is in the transmitting state.

In one embodiment of the present disclosure, under the initial state, the haze value of the light scattering switching element 1 may be between 50% and 99.5% (50%≤haze value≤99.5%), between 60% and 90% (60%≤haze value≤90%) or between 65% and 80% (65%≤haze value≤80%). In one embodiment of the present disclosure, when voltage is respectively applied to the first electrode layer 16 and the second electrode layer 17 to generate a vertical electric field between the first electrode layer 16 and the second electrode layer 17, the haze value of the light scattering switching element 1 may be between 0.5% and 20% (0.5%≤haze value≤20%), between 0.5% and 15% (0.5%≤haze value≤15%) or between 0.5% and 10% (0.5%≤haze value≤10%). In one embodiment of the present disclosure, when voltage is respectively applied to the first electrode layer 16 and the second electrode layer 17 to generate a vertical electric field between the first electrode layer 16 and the second electrode layer 17, the transmittance of the light scattering switching element 1 to light with wavelengths between 380 nm and 780 nm may be between 70% and 90% (70%≤transmittance≤90%) or between 75% and 85% (75%≤transmittance≤85%).

In the present disclosure, as shown in FIG. 1C, by adjusting the thickness T1 of the first light modulation layer 1, the haze value of the light scattering switching element 1 under the initial state can be controlled. In one embodiment of the present disclosure, as shown in FIG. 1C, the light scattering switching element 1 may further comprise a plurality of spacers SP disposed between the first alignment layer 14 and the second alignment layer 15. The thickness T1 of the first light modulation layer 13 may be approximately equal to the heights H1 of the spacers SP. By measuring the heights H1 of the spacers SP, the thickness T1 of the first light modulation layer 13 can be obtained; but the present disclosure is not limited thereto. The “height of the spacer” may be, for example, the maximum size of the spacer SP in the normal direction of the first substrate 11 (for example, the Z direction). In one embodiment of the present disclosure, the thickness T1 of the first light modulation layer 13 may be the distance between the first alignment layer 14 and the second alignment layer 15 in the normal direction of the first substrate 11 (for example, the Z direction). In the present disclosure, the thickness T1 of the first light modulation layer 13 may be between 10 μm and 100 μm (10 μm≤T1≤100 μm), between 15 μm and 95 μm (15 μm≤T1≤95 μm), between 20 μm and 90 μm (20 μm≤T1≤90 μm), between 25 μm and 85 μm (25 μm≤T1≤85 μm), between 30 μm and 80 μm (30 μm≤T1≤80 μm), but the present disclosure is not limited thereto. In some embodiments, the spacer SP may contact the first alignment layer 14 and/or the second alignment layer 15, but the present disclosure is not limited thereto.

In some embodiments, the (positive) cholesteric liquid crystal 131 may has a pitch ranging from 700 nm to 3000 nm, a ratio of the thickness T1 of the first light modulation layer 13 to the pitch of the cholesteric liquid crystal 131 is greater than or equal to 5 and less than or equal to 20, but the present disclosure is not limited thereto. In some embodiments, the ratio of the thickness T1 of first light modulation layer 13 to the pitch of the cholesteric liquid crystal 131 is greater than or equal to 7 and less than or equal to 18. In some embodiments, the pitch of the cholesteric liquid crystal 131 may be obtained by the followings, but the present disclosure is not limited thereto. For example, a reference liquid crystal with a known pitch and the cholesteric liquid crystal 131 to be measured may be respectively injected into a wedge cell. By comparing the image interval between the reference liquid crystal and the cholesteric liquid crystal 131 with a microscope, the pitch of the cholesteric liquid crystal 131 can be proportional calculated from the pitch of the reference liquid crystal. The aforesaid measurement method is used as an example, and any method by which the pitch of the liquid crystal molecule 131 can be obtained and the resulting value are within the scope of the present disclosure.

In the present disclosure, the same or different materials may be used to prepare the first substrate 11 and the second substrate 12. The material of the first substrate 11 and the second substrate 12 may respectively comprise a rigid substrate or a flexible substrate, and for example, comprise glass, quartz, sapphire, ceramics, polycarbonate (PC), polyimide (PI), polyethylene terephthalate (PET), polymethylmethacrylate (PMMA), triacetate cellulose (TAC) film, other suitable substrate material or a combination thereof, but the present disclosure is not limited thereto. In the present disclosure, the thicknesses of the first substrate 11 and the second substrate 12 may be greater than or equal to 0.2 mm and less than or equal to 30 mm, but the present disclosure is not limited thereto. In the present disclosure, the thicknesses of the first substrate 11 and the second substrate 12 may be greater than or equal to 0.2 mm and less than or equal to 10 mm, but the present disclosure is not limited thereto. In the present disclosure, the thicknesses of the first substrate 11 and the second substrate 12 may be greater than or equal to 0.2 mm and less than or equal to 5 mm, but the present disclosure is not limited thereto.

In the present disclosure, the first light modulation layer 13 comprises the (positive) cholesteric liquid crystal 131. In the present disclosure, the cholesteric liquid crystal 131 of the first light modulation layer 13 may comprise polymer stabilized cholesteric texture (PSCT), other suitable cholesteric liquid crystal or a combination thereof, but the present disclosure is not limited thereto. In the present disclosure, the pitch of the (positive) cholesteric liquid crystal 131 may be between 700 nm and 3000 nm, (700 nm≤pitch≤3000 nm), between 800 nm and 2900 nm (800 nm≤pitch≤2900 nm), between 1000 nm and 2800 nm (1000 nm≤pitch≤2800 nm), between 1100 nm and 2700 nm (1100 nm≤pitch≤2700 nm), or between 1200 nm and 2600 nm (1200 nm≤pitch≤2600 nm). Thus, the (positive) cholesteric liquid crystal 131 may reflect light with wavelengths ranging from 700 nm to 3000 nm (700 nm≤wavelengths≤3000 nm), from 800 nm to 2900 nm (800 nm≤wavelengths≤2900 nm), from 1000 nm to 2800 nm (1000 nm≤wavelengths≤2800 nm), from 1100 nm to 2700 nm (1100 nm≤wavelengths≤2700 nm) or from 1200 nm to 2600 nm (1200 nm≤wavelengths≤2600 nm).

In some embodiments, the birefringence of the cholesteric liquid crystal 13 (Δn=ne−no) may be greater than or equal to 0.15 and less than or equal to 0.4, but the present disclosure is not limited thereto. In some embodiments, the birefringence of the cholesteric liquid crystal 13 (Δn=ne−no) may be greater than or equal to 0.15 and less than or equal to 0.35. In some embodiments, the birefringence of the cholesteric liquid crystal 13 (Δn=ne−no) may be greater than or equal to 0.15 and less than or equal to 0.3.

In the present disclosure, the same or different material may be used to prepare the first alignment layer 14 and the second alignment layer 15, but the present disclosure is not limited thereto. In the present disclosure, the first alignment layer 14 and the second alignment layer 15 may respectively be vertical aligned. The “vertical aligned/alignment” refers to, for example, the angle included between the long axis of the liquid crystal molecule and the alignment layer may be greater than or equal to 70° and less than or equal to 90° (70°≤angle≤90°) when no voltage is applied to electrodes to generate vertical electric field. As shown in FIG. 1D, when no voltage is applied to the electrodes to generate the vertical electric field, an angle θ1 is included between the direction of the long axis ax of the cholesteric liquid crystal 131 and the surface of the first alignment layer 14 (vertically aligned), and the angle θ1 may be greater than or equal to 70° and less than or equal to 90° (70°≤angle≤90°). Similarly, when no voltage is applied to the electrodes to generate the vertical electric field, an angle θ2 is included between the direction of the long axis ax of the cholesteric liquid crystal 131 and the surface of the second alignment layer 15 (vertically aligned), and the angle θ2 may be greater than or equal to 70° and less than or equal to 90° (70°≤angle≤90°).

In the present disclosure, the same or different materials may be used to prepare the first electrode layer 16 and the second electrode layer 17, and the materials of the first electrode layer 16 and the second electrode layer 17 may comprise a metal oxide, an alloy thereof or a combination thereof, but the present disclosure is not limited thereto. Suitable metal oxide includes, but is not limited to, indium tin oxide (ITO), indium zinc oxide (IZO), indium tin zinc oxide (ITZO), indium gallium zinc oxide (IGZO) or a combination thereof.

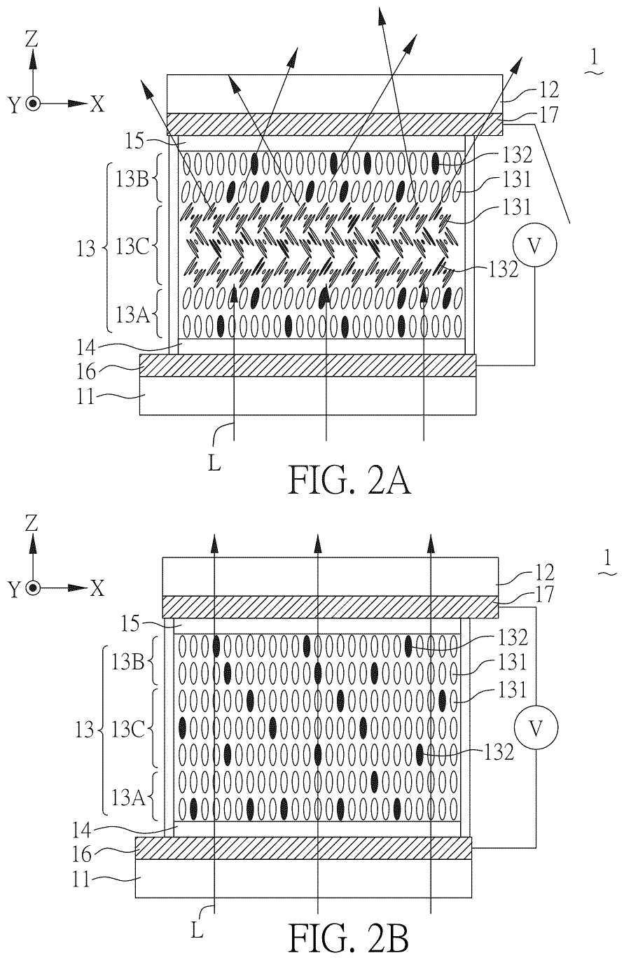

FIG. 2A and FIG. 2B are schematic views of a light scattering switching element according to one embodiment of the present disclosure. Except for the following differences, the light scattering switching element of FIG. 2A is similar to that of FIG. 1A, and the light scattering switching element of FIG. 2B is similar to that of FIG. 1B.

In one embodiment of the present disclosure, as shown in FIG. 2A and FIG. 2B, the first light modulation layer 13 may further comprise a dye material 132. By applying voltage to the first electrode layer 16 and the second electrode layer 17 respectively to generate the vertical electric field between the first electrode layer 16 and the second electrode layer 17, the arrangement of the cholesteric liquid crystal 131 and/or the dye material 132 can be controlled, so the light scattering switching element 1 can be switched between the (black) hazing state and the transmitting state.

As shown in FIG. 2A and the FIG. 2B, the first light modulation layer 131 may comprise a first portion 13A, a second portion 13B and a third portion 13C, wherein the first portion 13A is, for example, the portion close to the first alignment layer 14, the second portion 13B is, for example, the portion close to the second alignment layer 15, and the third portion 13C locates, for example, between the first portion 13A and the second portion 13B. When no voltage is applied to the first electrode layer 16 and the second electrode layer 17, no vertical electric field is generated between the first electrode layer 16 and the second electrode layer 17. As shown in FIG. 2A, the cholesteric liquid crystal 131 and/or the dye material 132 located in the first portion 13A of the first light modulation layer 13 is, for example, affected by the vertical alignment of the first alignment layer 14 and regularly arranged (for example, the long axis direction of the cholesteric liquid crystal 131 and/or the dye material 132 is approximately vertical to the first substrate 11); the cholesteric liquid crystal 131 and/or the dye material 132 located in the second portion 13B of the first light modulation layer 13 is, for example, affected by the vertical alignment of the second alignment layer 15 and regularly arranged (for example, the long axis of the cholesteric liquid crystal 131 and/or the dye material 132 is approximately vertical to the second substrate 12); and the cholesteric liquid crystal 131 and/or the dye material 132 located in the third portion 13C of the first light modulation layer 13 is far away from the first alignment layer 14 and the second alignment layer 15, not easily affected by the first alignment layer 14 or the second alignment layer 15 and arranged in disorder or irregularly. Thus, a part of the incident light L passes through the light scattering switching element 1 including such arranged cholesteric liquid crystals 131 and the light scattering switching element 1 is present in the scattering state or the hazing state; and a part of the incident light L is, for example, mostly absorbed by the irregular arranged dye materials 132 (for example, the dye material 132 in the third portion 13C) and the light scattering switching element 1 is present in the (black) hazing state. When the voltage is respectively applied to the first electrode layer 16 and the second electrode layer 17 to generate the vertical electric field between the first electrode layer 16 and the second electrode layer 17, as shown in FIG. 2B, the cholesteric liquid crystal 131 and/or the dye material 132 located in the first portion 13A of the first light modulation layer 13 is, for example, affected by the vertical alignment of the first alignment layer 14 and/or the vertical electric field to arrange regularly (for example, the long axes of the cholesteric liquid crystal 131 and the dye material 132 are approximately perpendicular to the first substrate 11); the cholesteric liquid crystal 131 and/or the dye material 132 located in the second portion 13B of the first light modulation layer 13 is, for example, affected by the vertical alignment of the second alignment layer 15 and/or the vertical electric field to arrange regularly (for example, the long axes of the cholesteric liquid crystal 131 and the dye material 132 are approximately perpendicular to the second substrate 12); and the cholesteric liquid crystal 131 and the dye material 132 located in the third portion 13C of the first light modulation layer 13 are affected by the vertical electric field and arranged regularly (for example, the long axes of the cholesteric liquid crystal 131 and/or the dye material 132 are approximately perpendicular to the first substrate 11 or the second substrate 12). Thus, most of the incident light L may pass through the cholesteric liquid crystal 131 and is not easily absorbed by the dye material 132, so the light scattering switching element 1 is present in the transmitting state.

In one embodiment of the present disclosure, under the initial state, the haze value of the light scattering switching element 1 may be between 50% and 99.5% (50%≤haze value≤99.5%), between 60% and 90% (60%≤haze value≤90%) or between 65% and 80% (65%≤haze value≤80%). As mentioned above, when the voltage is respectively applied to the first electrode layer 16 and the second electrode layer 17 to generate the vertical electric field between the first electrode layer 16 and the second electrode layer 17, the haze value of the light scattering switching element 1 may be between 0.5% and 20% (0.5%≤haze value≤20%), between 0.5% and 15% (0.5%≤haze value≤15%), between 0.5% and 12% (0.5%≤haze value≤12%) or between 0.5% and 10% (0.5%≤haze value≤10%). In one embodiment of the present disclosure, when the voltage is respectively applied to the first electrode layer 16 and the second electrode layer 17 to generate the vertical electric field between the first electrode layer 16 and the second electrode layer 17, the transmittance of the light scattering switching element 1 to light having wavelengths between 380 nm and 780 nm (380 nm≤wavelength≤780 nm) may range from 40% to 80% (40%≤transmittance≤80%), from 45% to 75% (45%≤transmittance≤75%) or from 50% to 70% (50%≤transmittance≤70%), but the present disclosure is not limited thereto.

In the present disclosure, the materials and other detail features of the first substrate 11, the second substrate 12, the cholesteric liquid crystal 131, the first alignment layer 14, the second alignment layer 15, the first electrode layer 16 and the second electrode layer 17 are as mentioned above, and are not described here again. In the present disclosure, the dye material 132 may comprise dichroic dye, which has absorption rate to the light with wavelengths between, for example, 380 nm and 780 nm (380 nm≤wavelength≤780 nm). The color absorbed by the dye material 132 may include, for example, black, purple, orange, blue, other colors or a combination thereof, but the present disclosure is not limited thereto.

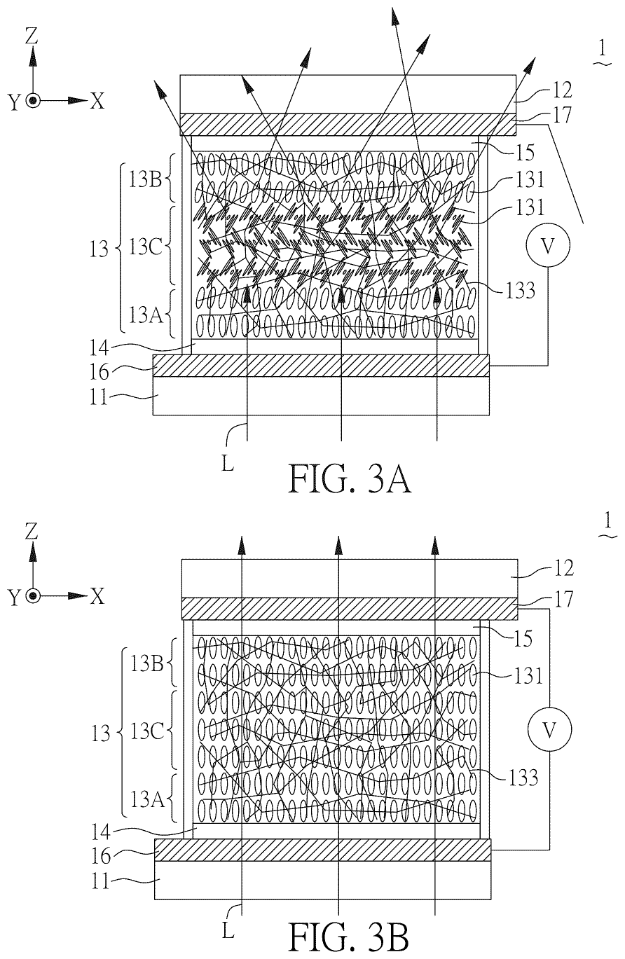

FIG. 3A and FIG. 3B are schematic views of a light scattering switching element according to one embodiment of the present disclosure. The light scattering switching element of FIG. 3A is similar to that shown in FIG. 1A, and FIG. 3A shows the aspect that the light scattering switching element is in the hazing state under the initial state. The light scattering switching element of FIG. 3B is similar to that shown in FIG. 1B, and FIG. 3B shows the aspect that the light scattering switching element is in the transmitting state when the voltage is respectively applied to the first electrode layer 16 and the second electrode layer 17 to generate the vertical electric field between the first electrode layer 16 and the second electrode layer 17. The differences between FIG. 3A. FIG. 3B, FIG. 1A and FIG. 1B are described as follows.

In one embodiment of the present disclosure, as shown in FIG. 3A and FIG. 3B, the (positive) cholesteric liquid crystal 131 in the first light modulation layer 13 may comprise polymer stabilized cholesteric texture (PSCT). The polymer 133 in the polymer stabilized cholesteric texture can stabilize the structure of the cholesteric liquid crystal 131 to increase the haze value of the light scattering switching element 1 under the initial state, or decrease the thickness of the first light modulation layer 13 to achieve the effect of improving taste or thinning the electronic device.

In the present disclosure, the materials and other detail features of the first substrate 11, the second substrate 12, the cholesteric liquid crystal 131, the first alignment layer 14, the second alignment layer 15, the first electrode layer 16 and the second electrode layer 17 may be as described above, and are not described again here.

In addition, even not shown in the figure, in another embodiment of the present disclosure, the first light modulation layer 13 may selectively comprise a (positive) cholesteric liquid crystal 131 and a dye material 132 (as shown in FIG. 2A), wherein the (positive) cholesteric liquid crystal 131 may be polymer stabilized cholesteric texture. As mentioned above, the polymer stabilized cholesteric texture can be used to increase the haze value of the light scattering switching element 1 under the initial state or decrease the thickness of the first light modulation layer 13, to achieve the effect of improving taste or thinning the electronic device. Furthermore, a part of the incident light L can be absorbed by the dye material 132 (as shown in FIG. 2A), so the light scattering switching element 1 is in a black hazing state under the initial state.

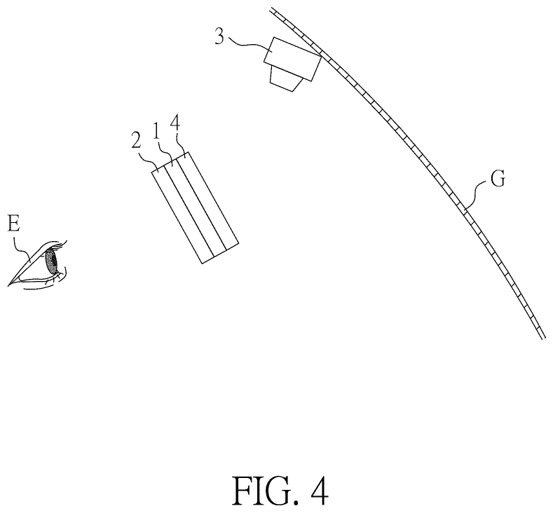

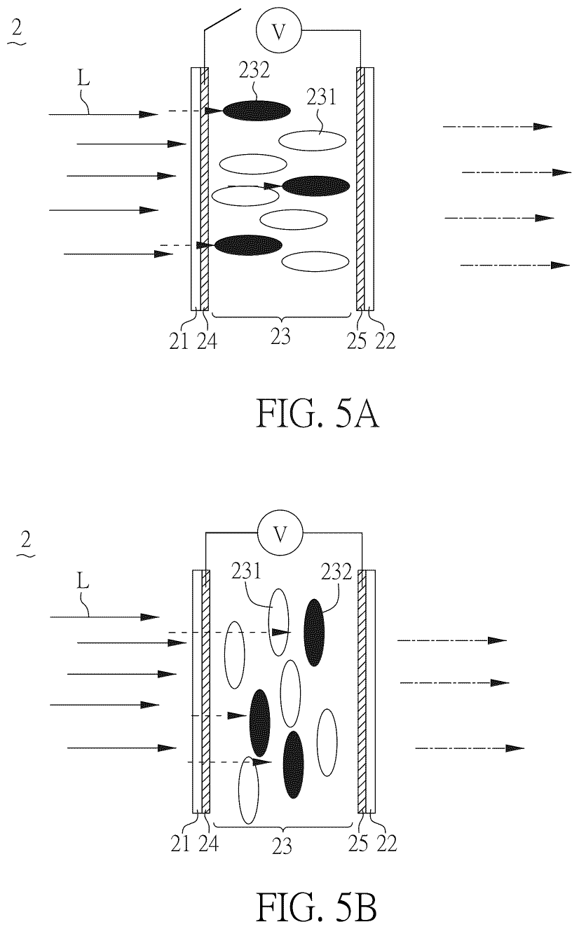

FIG. 4 is a schematic view showing a part of an electronic device according to one embodiment of the present disclosure. FIG. 5A and FIG. 5B are schematic views of a light absorption switching element according to one embodiment of the present disclosure.

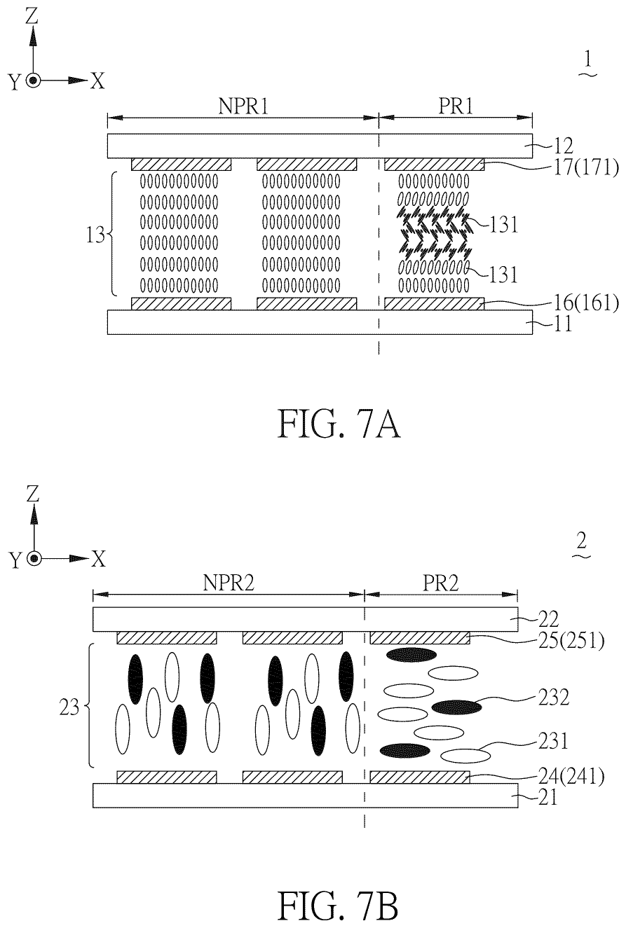

In one embodiment of the present disclosure, as shown in FIG. 4, the electronic device may comprise: a light scattering switching element 1; a light absorption switching element 2 adjacent to one side of the light scattering switching element 1; and an image generation element 3 for generating an image, wherein the light scattering switching element 1 is disposed between the light absorption switching element 2 and the image generation element 3. Herein, under a projection mode, the light scattering switching element 1 and the light absorption switching element 2 respectively comprise a projection region (which can be referred to the subsequent descriptions of FIG. 7A to FIG. 7B). For example, in FIG. 7A, the projection region PR1 of the light scattering switching element 1 is in the hazing state, and the projection region PR2 of the light absorption switching element 2 is in the grayscale state. The light scattering switching element 1 and the light absorption switching element 2 are combined to form a mode-switchable electronic device, which can switch between the light-shielding mode, the light-transmitting mode or other grayscale modes to achieve the effect of blocking external light (or ambient light) or penetrating external light (or ambient light). In addition, by combining with the image generation element 3, the electronic device has a projection function to display images (including but not limited to text or pictures). In one embodiment of the present disclosure, the electronic device may be a mode-switchable electronic device, which can be used in sun visors with head-up display function or other suitable applications.

In one embodiment of the present disclosure, as shown in FIG. 4, when the electronic device of the present disclosure is used as a sun visor (for example, a passenger sun visor), the image generation element 3 may be disposed adjacent to the windshield substrate G, and the light scattering switching element 1 and the light absorption switching element 2 may be disposed between the image generation element 3 and the viewer E; but the present disclosure is not limited thereto. Under the projection mode, the image generation element 3 can project images to the light scattering switching element 1 and/or the light absorption switching element 2. The images, for example, at least partially pass through the light scattering switching element 1 and/or the light absorption switching element 2 in sequence and then projected. The light scattering switching element 1 and the light absorption switching element 2 can selectively adjust the penetration of external light (such as light incident from the windshield substrate G) according to needs by switching between the light-shielding mode, the light-transmitting mode or other grayscale modes. In other words, when the electronic device is in the light-shielding mode, most of the external light can be blocked. When the electronic device is in the light-transmitting mode, most of the external light may, for example, pass through the electronic device, and the electronic device may be translucent and will not affect the driver's vision. Thus, no need to manually fold and store the sun visor when not in use.

In one embodiment of the present disclosure, as shown in FIG. 4, the electronic device may further comprise an anti-glare element 4, and the light scattering switching element 1 is disposed between the anti-glare element 4 and the light absorption switching element 2. In addition, compared to the light scattering switching element 1 (or the anti-glare element 4), the light absorption switching element 2 is closer to a viewer side (for example, viewer E). The light absorption switching element 2 at least absorbs the light scattered by the light scattering switching element 1, reducing the problem of the white hazing state of the images, and improving the viewing quality of the projection; but the present disclosure is not limited thereto. The anti-glare element 4, for example, can be used to block most of the horizontally polarized light in the external light to reduce the horizontally polarized light from penetrating the electronic device and reaching the eyes of viewer E, thus reducing the generation of glare; but the present disclosure is not limited thereto. In other embodiments, the anti-glare element 4 can be adjusted according to needs and used to block polarized light in the appropriate direction. In the present disclosure, the anti-glare element 4 may comprise a polarizing element, which may comprise, for example, a non-switchable polarizing element or a switchable polarizing element, but the present disclosure is not limited thereto. The switchable polarizing element, for example, comprises but not limited to a polarizing element that can switch the transmitting state or the polarization state.

In the present disclosure, the image generation element 3, for example, comprise a projector or other suitable image generation element. In one embodiment of the present disclosure, the structures and other features of the light scattering switching element 1 may be as shown in FIG. 1A and FIG. 1B as well as FIG. 3A and FIG. 3B and are not described again here. In one embodiment of the present disclosure, the light absorption switching element 2 may be as shown in FIG. 5A and FIG. 5B and described in detail below.

In one embodiment of the present disclosure, as shown in FIG. 5A and FIG. 5B, the light absorption switching element 2 may comprise: a third substrate 21; a fourth substrate 22 disposed opposite to the third substrate 21; a second light modulation layer 23 disposed between the third substrate 21 and the fourth substrate 22; a third electrode layer 24 disposed between the third substrate 21 and the second light modulation layer 23; and a fourth electrode layer 25 disposed between the fourth substrate 22 and the second light modulation layer 23; wherein the second light modulation layer 23 comprises a liquid crystal material 231 and a dye material 232. By respectively applying voltage to the third electrode layer 24 and the fourth electrode layer 25 to generate a vertical electric field between the third electrode layer 24 and the fourth electrode layer 25, the arrangement of the liquid crystal material 231 and/or the dye material 232 in the second light modulation layer 23 can be controlled, and the light absorption switching element 2 can be switched between the absorption state and the transmitting state. In other embodiments (now shown in the figure), the third electrode layer 24 and the fourth electrode layer 25 may be, for example, formed on the same substrate. For example, the third electrode layer 24 and the fourth electrode layer 25 may be formed between the third substrate 21 and the second light modulation layer 23. The third electrode layer 24 and the fourth electrode layer 25 may be the electrode layers located on the same layer or different layers. When the third electrode layer 24 and the fourth electrode layer 25 are located on the same layer, the voltage is applied to the third electrode layer 24 and the fourth electrode layer 25 to present the in-plane-switching (IPS) structure, but the present disclosure is not limited thereto. When the third electrode layer 24 and the fourth electrode layer 25 are located on different layers, the voltage is applied to the third electrode layer 24 and the fourth electrode layer 25 to present the fringe-field switching (FFS) structure, but the present disclosure is not limited thereto.

In one embodiment of the present disclosure, when no voltage is applied to the third electrode layer 24 and the fourth electrode layer 25, as shown in FIG. 5A, the long axes of the liquid crystal material 231 and the dye material 232 in the second light modulation layer 23 are, for example, approximately perpendicular to the polarization direction (such as the horizontal polarization direction, the vertical polarization direction) of the incident light L, and the incident light L is, for example, not easily absorbed by the dye material 232, so the light absorption switching element 2 is present in the transmitting state. When the voltage is respectively applied to the third electrode layer 24 and the fourth electrode layer 25 to generate a vertical electric field between the third electrode layer 24 and the fourth electrode layer 25, as shown in FIG. 5B, the long axes of most of the liquid crystal material 231 and/or the dye material 232 in the second light modulation layer 23 are, for example, approximately parallel to the polarization direction (for example, vertical polarization direction) of the incident light L, and the light absorption switching element 2 is present in the absorption state or the grayscale state.

In the present disclosure, the same or different materials may be used to prepare the third substrate 21 and the fourth substrate 22, and the materials of the third substrate 21 and the fourth substrate 22 may be respectively as described for the first substrate 11 or the second substrate 12, and are not described again here. In the present disclosure, the second light modulation layer 23 may comprise a guest host type liquid crystal (GHLC) and for example, comprise a liquid crystal material 231 and a dye material 232, wherein the liquid crystal material 231 comprise a negative liquid crystal; but the present disclosure is not limited thereto. In the present disclosure, the dye material 232 may comprise a dichroic dye, which has absorption rate to the light with wavelengths between, for example, 380 nm and 780 nm (380 nm≤wavelength≤780 nm). The color absorbed by the dye material 232 can be referred to above. In the present disclosure, the same or different materials may be used to prepare the third electrode layer 24 and the fourth electrode layer 25, and the materials of the third electrode layer 24 and the fourth electrode layer 25 may be respectively as described for the first electrode layer 16 or the second electrode layer 17, and are not described again here. The above manner for switching the absorption state and the transmitting state of the light absorption switching element 2 are used as an example, and the light absorption switching element 2 may be switched by other manners.

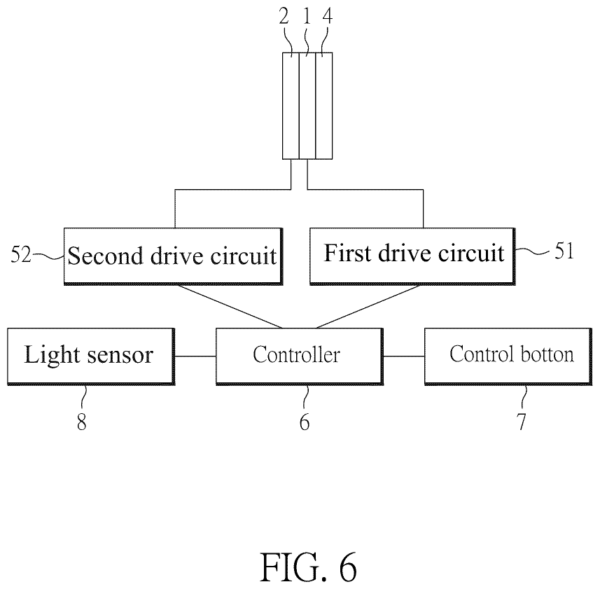

FIG. 6 is a schematic view showing a part of an electronic device according to one embodiment of the present disclosure.

In one embodiment of the present disclosure, as shown in FIG. 6, the electronic device may comprise: a first drive circuit 51 electrically connected to the light scattering switching element 1; a second drive circuit 52 electrically connected to the light absorption switching element 2; and a controller 6 electrically connected to the first drive circuit 51 and/or the second drive circuit 52. The first drive circuit 51 and the second drive circuit 52 may respectively provide different voltages to the light scattering switching element 1 (for example, the electrodes in the light scattering switching element 1) and the light absorption switching element 2 (for example, the electrodes in the light absorption switching element 2) according to the control of the controller 6 (for example, but not limited to a microprocessor MCU). In other embodiments, the first drive circuit 51 and the second drive circuit 52 may be, for example, controlled by different controllers 6.

More specifically, for example, as shown in FIG. 1A, FIG. 1B and FIG. 6, the first drive circuit 51 may be electrically connected to the first electrode layer 16 and the second electrode layer 17 of the light scattering switching element 1 respectively, to respectively provide or apply voltage to the first electrode layer 16 and the second electrode layer 17, thereby achieving the effect of controlling the arrangement of the cholesteric liquid crystal 131 in the first light modulation layer 13, so the light scattering switching element 1 can be switched between the hazing state and the transmitting state. Similarly, for example, as shown in FIG. 5A, FIG. 5B and FIG. 6, the second drive circuit 52 may be electrically connected to the third electrode layer 24 and the fourth electrode layer 25 of the light absorption switching element 2 respectively, to respectively provide or apply voltage to the third electrode layer 24 and the fourth electrode layer 25, thereby achieving the effect of controlling the arrangement of the liquid crystal material 231 and/or the dye material 232 in the second light modulation layer 23, so the light absorption switching element 2 can be switched between the absorption state and the transmitting state.

In one embodiment of the present disclosure, as shown in FIG. 6, the electronic device may selectively comprise a control button 7 and an (environmental) light sensor 8, the control button 7 and the (environmental) light sensor 8 are, for example, electrically connected to the controller 6 respectively, but the present disclosure is not limited thereto. The control button 7 can be used to manually control the controller 6, thereby controlling the voltage provided or applied to the light scattering switching element 1 and the light absorption switching element 2 through the first drive circuit 51 and the second drive circuit 52. The (environmental) light sensor 8 can sense the intensity of external light (such as external ambient light) and provide the sensed information to the controller 6, and the controller 6 can control the first drive circuit 51 and/or the second drive circuit 52 according to the sensed information provided by the (environmental) light sensor 8. Thus, the first drive circuit 51 and/or the second drive circuit 52 can provide or apply suitable voltage to the electrodes in the light scattering switching element 1 and/or the electrodes in the light absorption switching element 2, so the light scattering switching element 1 can be switched between the hazing state and the transmitting state, thereby the effect of switching the light absorption switching element 2 between the absorption state and the transmitting state can be achieved.

FIG. 7A is a schematic view of a light scattering switching element according to one embodiment of the present disclosure. FIG. 7B is a schematic view of a light absorption switching element according to one embodiment of the present disclosure.

In one embodiment of the present disclosure, the light scattering switching element 1 and the light absorption switching element 2 may be respectively partition-driven designs. As shown in FIG. 7A, the first electrode layer 16 of the light scattering switching element 1 may comprise a plurality of first electrodes 161 separated from each other; the second electrode layer 17 of the light scattering switching element 1 may comprise a plurality of second electrodes 171 separated from each other. For example, the first electrodes 161 and the second electrodes 171 are overlapped in the normal direction of the first substrate 11 (for example, the Z direction). The voltage may be selectively applied to different first electrodes 161 and second electrodes 171 to control the cholesteric liquid crystal 131 in the corresponding regions, so the cholesteric liquid crystal 131 in different regions may respectively be present in the hazing state or the transmitting state to achieve the effect of partition driving or switching the hazing state or transmitting state. More specifically, as shown in FIG. 7A, under the projection mode, the light scattering switching element 1 may comprise a projection region PR1 and a non-projection region NPR1. For example, no electric field is applied to the first electrode 161 and the second electrode 171 corresponding to the projection region PR1, so that the potential difference between them is 0; and an electric field is applied to the first electrode 161 and the second electrode 171 corresponding to the non-projection region NPR1, so that the potential difference between them is greater than 0. Thus, the first light modulation layer 13 of the light scattering switching element 1 corresponding to the projection region PR1 is, for example, in the hazing state, and it is conducive to the image generation element 3 (shown in FIG. 4) to generate images in the hazing state; and the light scattering switching element 1 corresponding to the non-projection region NPR1 is, for example, in the transmitting state to facilitate light penetration; but the present disclosure is not limited thereto.

Similarly, as shown in FIG. 7B, the third electrode layer 24 of the light absorption switching element 2 may comprise a plurality of third electrodes 241 separated from each other; and the fourth electrode layer 25 of the light absorption switching element 2 may comprise a plurality of fourth electrodes 251 separated from each other. For example, the third electrodes 241 and the fourth electrodes 251 may be overlapped in the normal direction of the third substrate 21 (for example, the Z direction). The voltage may be selectively applied to different third electrodes 241 and fourth electrodes 251 to control the liquid crystal material 231 and the dye material 232 in the corresponding regions, so different regions can be present in the transmitting state or the absorption state respectively to achieve the effect of partition driving or switching transmitting state or absorption state. More specifically, as shown in FIG. 7B, under the projection mode, the light absorption switching element 2 may comprise a projection region PR2 and a non-projection region NPR2. For example, the voltage is respectively applied to the third electrode 241 and the fourth electrode 251 corresponding to the projection region PR2 to generate a vertical electric field between the third electrode 241 and the fourth electrode 251 corresponding to the projection region PR2, so the potential difference between them is greater than 0; and no voltage is applied to the third electrode 241 and the fourth electrode 251 corresponding to the non-projection region NPR2, so no electric field is generated between the third electrode 241 and the fourth electrode 251 in the non-projection region NPR2 and the potential difference between them is 0. Thus, the light absorption switching element 2 corresponding to the projection region PR2 may be, for example, present in the absorption state or the grayscale state to facilitate the image generation element 3 (as shown in FIG. 4) to generate images, and the light scattering switching element 2 corresponding to the non-projection region NPR2 may be, for example, present in the transmitting state to facilitate the light passing through; but the present disclosure is not limited thereto. As described above, under the projection mode, the images generated by the image generation element 3 may, for example, at least partially pass through the light scattering switching element 1 and/or the light absorption switching element 2 in sequence and be projected. For example, the projection region PR1 of the light scattering switching element 1 and the projection region PR2 of the light absorption switching element 2 may respectively be the regions that the images pass through the light scattering switching element 1 and the light absorption switching element 2 and display; and the non-projection region NPR1 of the light scattering switching element 1 and the non-projection region NPR2 of the light absorption switching element 2 may respectively be the regions other than the projection regions (the projection region PR1 or the projection region PR2).

In one embodiment of the present disclosure, the electronic device shown in FIG. 4 may be a mode-switchable electronic device, which can be, for example, switched between the light-shielding mode and the light-transmitting mode. In addition, since the electronic device of the present embodiment comprises the image generation element 3, it can be switched to the projection mode to display images if it is needed. The corresponding component relationships between each mode are shown in Table 1 below.

TABLE 1

| | Image | | |
|---|---|---|---|
| | generation | Light scattering | Light absorption |
| Mode | element | switching element | switching element |
| Light-shielding | OFF | Hazing state/ | Absorption state |
| mode | | transmitting state | |
| Light- | OFF | Transmitting state | Transmitting state |
| transmitting mode | | | |
| Projection mode | ON | Hazing state | Grayscale state |
| | | (projection region) | (projection region) |
| | | Transmitting state | Transmitting state |
| | | (non-projection | (non-projection |
| | | region) | region) |

When the electronic device is in the light-shielding mode, for example, the image generation element 3 is not needed to start, the light scattering switching element 1 may be in the hazing state or the transmitting state, and the light absorption switching element 2 is in the absorption state. More specifically, in the light-shielding mode, when the light scattering switching element 1 in the hazing state, the haze value thereof may be switched to greater than 75% and less than or equal to 99.5% (75%≤haze value≤99.5%) or greater than 80% and less than or equal to 95% (80%≤haze value≤95%), but the present disclosure is not limited thereto. In other embodiments, the light scattering switching element 1 may be in the transmitting state. Under the light-shielding mode, the transmittance of the light absorption switching element 2 to light with wavelengths between 380 nm and 780 nm (380 nm≤wavelength≤780 nm) may be less than 20%, for example, may be greater than or equal to 1% and less than 20% (1%≤transmittance≤20%), greater than or equal to 1% and less than or equal to 15% (1%≤transmittance≤15%), or greater than or equal to 1% and less than or equal to 10% (1%≤transmittance≤10%); but the present disclosure is not limited thereto. When the haze value of the light scattering switching element 1 and the transmittance of the light absorption switching element 2 to light with wavelengths between 380 nm and 780 nm satisfy the aforesaid range, the electronic device may have better light shielding effect, but the present disclosure is not limited thereto. The haze value of the light scattering switching element 1 and the transmittance of the light absorption switching element 2 to light with wavelengths between 380 nm and 780 nm may be adjusted according to the user habits.

When the electronic device is in the light-transmitting mode, the image generation element 3 is not needed to start, the light scattering switching element 1 is in the transmitting state, and the light absorption switching element 2 is in the transmitting state. More specifically, in the light-transmitting mode, the haze value of the light scattering switching element 1 may be greater than or equal to 0.5% and less than or equal to 20% (0.5%≤haze value≤20%), greater than or equal to 0.5% and less than or equal to 15% (0.5%≤haze value≥15%), or greater than or equal to 0.5% and less than or equal to 10% (0.5%≤haze value≤10%); but the present disclosure is not limited thereto. Under the light-transmitting mode, the transmittance of the light absorption switching element 2 to light with wavelengths between 380 nm and 780 nm (380 nm≤wavelength≤780 nm) may be greater than or equal to 40% and less than or equal to 85% (40%≤transmittance≤85%), greater than or equal to 45% and less than or equal to 80% (45%≤transmittance≤80%), or greater than or equal to 45% and less than or equal to 70% (45%≤transmittance≤70%); but the present disclosure is not limited thereto. When the haze value of the light scattering switching element 1 and the transmittance of the light absorption switching element 2 satisfy the aforesaid ranges, the electronic device may have better light transmitting effect; but the present disclosure is not limited thereto. The haze value of the light scattering switching element 1 and the transmittance of the light absorption switching element 2 may be adjusted according to the user habits.

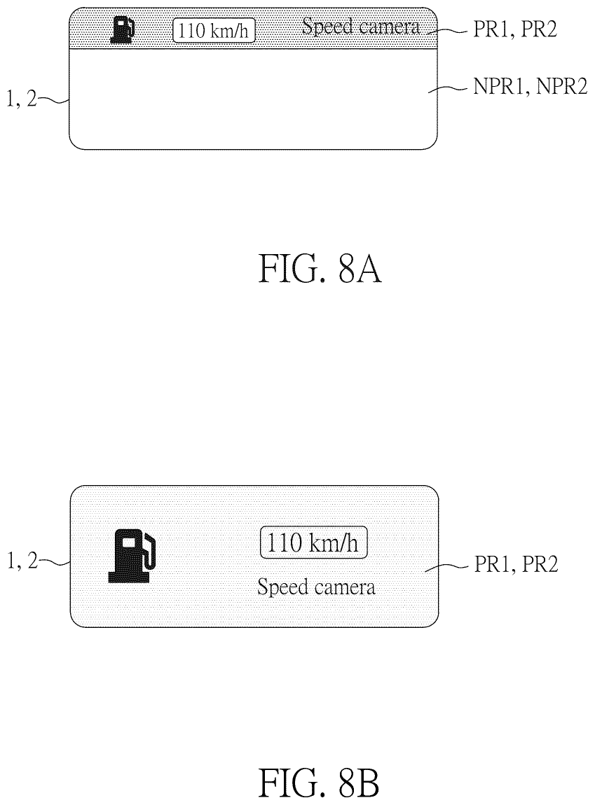

In the present disclosure, as shown in FIG. 7A and FIG. 7B, the light scattering switching element 1 may have a projection region PR1 and a non-projection region NPR1. The light absorption switching element 2 may have a projection region PR2 and a non-projection region NPR2. The projection region PR1 of the light scattering switching element 1 and the projection region PR2 of the light absorption switching element 2 are as defined above, the non-projection region NPR1 of the light scattering switching element 1 and the non-projection region NPR2 of the light absorption switching element 2 are as defined above, and are not described again here. The projection region PR1 of the light scattering switching element 1 and the projection region PR2 of the light absorption switching element 2 may be approximately overlapped (as shown in FIG. 8A), the non-projection region NPR1 of the light scattering switching element 1 and the non-projection region NPR2 of the light absorption switching element 2 may be approximately overlapped (as shown in FIG. 8A). In some embodiments, under the projection mode, the image generation element 3 is started. For example, the projection region PR1 of the light scattering switching element 1 is in the hazing state, and the non-projection region NPR1 thereof is in the transmitting state. For example, the projection region PR2 of the light absorption switching element 2 is in the grayscale state, and the non-projection region NPR2 thereof is in the transmitting state, but the present disclosure is not limited thereto. More specifically, under the projection mode, the haze value of the projection region PR1 of the light scattering switching element 1 may be greater than or equal to 50% and less than or equal to 99.5% (50%≤haze value≤99.5%) or greater than 60% and less than or equal to 95% (60%≤haze value≤95%), and the haze value may be adjusted according to the user habits. Under the projection mode, the transmittance of the projection region PR2 of the light absorption switching element 2 to light with wavelengths between 380 nm and 780 nm (380 nm≤wavelength≤780 nm) may be greater than or equal to 40% and less than or equal to 75% (40%≤transmittance≤75%), greater than or equal to 45% and less than or equal to 70% (45%≤transmittance≤70%), or greater than or equal to 50% and less than or equal to 70% (50%≤transmittance≤70%), and the transmittance may be adjusted according to the user habits. When the haze value of the projection region PR1 of the light scattering switching element 1 and the transmittance of the projection region PR2 of the light absorption switching element 2 satisfy the aforesaid ranges, the projection region PR1 and the projection region PR2 may show better projection effect. In addition, under the projection mode, the haze value of the non-projection region NPR1 of the light scattering switching element 1 may be, for example, greater than or equal to 0.5% and less than or equal to 20% (0.5%≤haze value≤20%), greater than or equal to 0.5% and less than or equal to 15% (0.5%≤haze value≤15%), or greater than or equal to 0.5% and less than or equal to 10% (0.5%≤haze value≤10%), and the haze value can be adjusted according to the user habits. Under the projection mode, the transmittance of the non-projection region NPR2 of the light absorption switching element 2 to light with wavelengths between 380 nm and 780 nm (380 nm≤wavelength≤780 nm) may be greater than or equal to 40% and less than or equal to 85% (40%≤transmittance≤85%), greater than or equal to 45% and less than or equal to 80% (45%≤transmittance≤80%), or greater than or equal to 45% and less than or equal to 70% (45%≤transmittance≤70%), and the transmittance can be adjusted according to the user habits. When the haze value of the non-projection region NPR1 of the light scattering switching element 1 and the transmittance of the non-projection region NPR2 of the light absorption switching element 2 satisfy the aforesaid ranges, the non-projection regions NPR1, NPR2 can show better transmitting effect. In one embodiment of the present disclosure, under the projection mode, the haze value of the projection region PR1 of the light scattering switching element 1 may be greater than the haze value of the non-projection region NPR1 of the light scattering switching element 1.

FIG. 8A and FIG. 8B are schematic views showing an electronic device under a projection mode according to one embodiment of the present disclosure.

In one embodiment, as shown in FIG. 8A, under the projection mode, the projection region PR1 of the light scattering switching element 1 and the projection region PR2 of the light absorption switching element 2 are approximately overlapped, and the non-projection region NPR1 of the light scattering switching element 1 and the non-projection region NPR2 of the light absorption switching element 2 are approximately overlapped. The image generation element 3 (as shown in FIG. 4) may project images to the projection region PR1 and the projection region PR2 according to the control, so drivers can obtain information (including but not limited to text or images) through electronic devices, such as speed display, speed camera warnings, etc., but the present disclosure is not limited thereto; and the non-projection region NPR1 and the non-projection region NPR2 may be respectively in the transmitting state. In one embodiment of the present disclosure, the area of the non-projection region NPR1 (and/or the non-projection region NPR2) may be the same or different from the area of the projection region PR1 (and/or the projection region PR2). In one embodiment of the present disclosure, the area of the non-projection region NPR1 (and/or the non-projection region NPR2) may be greater than the area of the projection region PR1 (and/or the projection region PR2), but the present disclosure is not limited thereto. In one embodiment of the present disclosure (not shown in the figure), the area of the non-projection region NPR1 (and/or the non-projection region NPR2) may be less than the area of the projection region PR1 (and/or the projection region PR2), but the present disclosure is not limited thereto.

In one embodiment of the present disclosure, the position of the projection region PR1 (and/or the projection region PR2) may be adjusted according to needs, for example, may be adjusted to be located at the upper side, the bottom side, the left side, the right side or in the middle. In one embodiment, the areas of the projection region PR1 and the projection region PR2 can be reduced or enlarged according to needs. In one embodiment, as shown in FIG. 8B, under the projection mode, the light scattering switching element 1 and the light absorption switching element 2 may not respectively have the non-projection region. That is, the light scattering switching element 1 and the light absorption switching element 2 respectively have only the projection region PR1 and the projection region PR2. At this time, the image generation element 3 (as shown in FIG. 4) can, for example, project the entire area to display the image, but the present disclosure is not limited thereto. In one embodiment of the present disclosure (not shown in the figure), the light scattering switching element 1 and the light absorption switching element 2 may respectively have a plurality of projection regions PR1 and projection regions PR2, and the projection regions PR1 and the projection regions PR2 may be, for example, separated from each other and located in different regions.

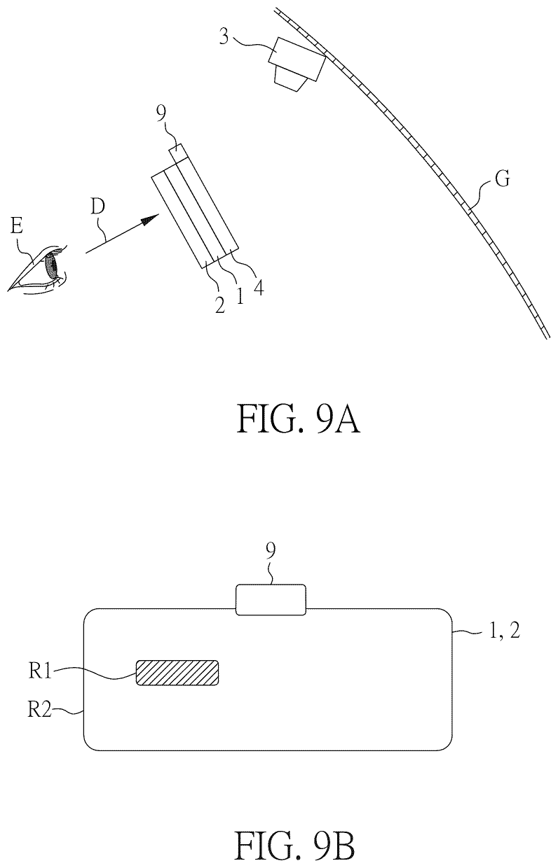

FIG. 9A is a schematic view showing a part of an electronic device according to one embodiment of the present disclosure. FIG. 9B is a partial schematic view of FIG. 9A. The electronic device of FIG. 9 is similar to that shown in FIG. 4, except for the following differences.

In one embodiment of the present disclosure, as shown in FIG. 9A and FIG. 9B, the electronic device may further comprise a detection module 9 disposed adjacent to the light scattering switching element 1. The detection module 9 can be used to detect the position of the viewer E, and the electronic device is switched to the light-shielding mode in a specific region (for example, the first region R1 of FIG. 9B) through calculation, but the present disclosure is not limited thereto.

More specifically, FIG. 9B is, for example, a schematic view of the electronic device observed from the sight direction D of the viewer E in FIG. 9A. The electronic device may comprise a first region R1 and a second region R2. When the detection module 9 detects the position of the viewer E, after calculation, the first region R1 of the electronic device is switches to the light-shielding mode, and the second region R2 thereof is maintained in the light-transmitting mode; but the present disclosure is not limited thereto. Thus, it can block light while reducing the area of the light-shielding region (such as the first region R1) to improve the overall openness of the sight. In one embodiment of the present disclosure, the area of the first region R1 may be less than the area of the second region R2, but the present disclosure is not limited thereto.

The above specific embodiments should be construed as merely illustrative without limiting the remainder of the disclosure in any way, and features of different embodiments may be mixed and matched as long as they do not conflict with each other.

Although the present disclosure has been explained in relation to its embodiment, it is to be understood that many other possible modifications and variations can be made without departing from the spirit and scope of the disclosure as hereinafter claimed.

1. An electronic device, comprising:
a light scattering switching element, comprising:
a first substrate;
a second substrate disposed opposite to the first substrate;
a first light modulation layer disposed between the first substrate and the second substrate, wherein the first light modulation layer comprises a positive cholesteric liquid crystal;
a first alignment layer disposed between the first substrate and the first light modulation layer and vertically aligned;
a second alignment layer disposed between the second substrate and the first light modulation layer and vertically aligned;
a first electrode layer disposed between the first substrate and the first alignment layer; and
a second electrode layer disposed between the second substrate and the second alignment layer,
wherein the light scattering switching element is in a hazing state under an initial state,
wherein when voltage is respectively applied to the first electrode layer and the second electrode layer to generate a vertical electric field between the first electrode layer and the second electrode layer, the light scattering switching element is in a transmitting state.

2. The electronic device of claim 1, wherein the first light modulation layer has a thickness ranging from 10 μm to 100 μm.

3. The electronic device of claim 1, wherein the light scattering switching element has a haze value ranging from 50% to 99.5% under the initial state.

4. The electronic device of claim 1, wherein the light scattering switching element has a haze value ranging from 60% to 90% under the initial state.

5. The electronic device of claim 1, wherein the positive cholesteric liquid crystal has a pitch ranging from 700 nm to 3000 nm.

6. The electronic device of claim 1, wherein the light scattering switching element has a haze value ranging from 0.5% to 20% and a transmittance of the light scattering switching element to light with wavelengths between 380 nm to 780 nm is between 70% to 90% when the voltage is respectively applied to the first electrode layer and the second electrode layer to generate the vertical electric field between the first electrode layer and the second electrode layer.

7. The electronic device of claim 1, wherein the light scattering switching element has a haze value ranging from 0.5% to 15% and a transmittance of the light scattering switching element to light with wavelengths between 380 nm to 780 nm is between 75% to 85% when the voltage is respectively applied to the first electrode layer and the second electrode layer to generate the vertical electric field between the first electrode layer and the second electrode layer.

8. The electronic device of claim 1, wherein the positive cholesteric liquid crystal comprises polymer stabilized cholesteric texture.

9. The electronic device of claim 1, wherein the first light modulation layer further comprises a dye material.

10. The electronic device of claim 9, wherein the light scattering switching element has a haze value ranging from 0.5% to 20% and a transmittance of the light scattering switching element to light with wavelengths between 380 nm to 780 nm is between 40% to 80% when the voltage is respectively applied to the first electrode layer and the second electrode layer to generate the vertical electric field between the first electrode layer and the second electrode layer.

11. The electronic device of claim 9, wherein the light scattering switching element has a haze value ranging from 0.5% to 15% and a transmittance of the light scattering switching element to light with wavelengths between 380 nm to 780 nm is between 45% to 75% when the voltage is respectively applied to the first electrode layer and the second electrode layer to generate the vertical electric field between the first electrode layer and the second electrode layer.

12. The electronic device of claim 1, further comprising:
a light absorption switching element adjacent to one side of the light scattering switching element; and
an image generation element for generating an image, wherein the light scattering switching element is disposed between the light absorption switching element and the image generation element,
wherein, under a projection mode, the light scattering switching element and the light absorption switching element respectively comprises a projection region, the projection region of the light scattering switching element is in a hazing state and the projection region of the light absorption switching element is in a grayscale state.

13. The electronic device of claim 12, wherein under the projection mode, the projection region of the light scattering switching element has a haze value ranging from 50% to 99.5%, and a transmittance of the projection region of the light absorption switching element to light with wavelengths between 380 nm to 780 nm is greater than or equal to 40% and less than or equal to 75%.

14. The electronic device of claim 12, wherein under the projection mode, the projection region of the light scattering switching element has a haze value ranging from 60% to 95%, and a transmittance of the projection region of the light absorption switching element to light with wavelengths between 380 nm to 780 nm is greater than or equal to 45% and less than or equal to 70%.

15. The electronic device of claim 12, further comprising an anti-glare element, wherein the light scattering switching element is disposed between the anti-glare element and the light absorption switching element.

16. The electronic device of claim 12, wherein the light absorption switching element comprises:
a third substrate;
a fourth substrate disposed opposite to the third substrate;
a second light modulation layer disposed between the third substrate and the fourth substrate;
a third electrode layer disposed between the third substrate and the second light modulation layer; and
a fourth electrode layer disposed between the fourth substrate and the second light modulation layer.

17. The electronic device of claim 16, wherein the light absorption switching element is present in the absorption state or the grayscale state when voltage is respectively applied to the third electrode layer and the fourth electrode layer to generate a vertical electric field between the third electrode layer and the fourth electrode layer.

18. The electronic device of claim 16, wherein the second light modulation layer comprises a liquid crystal material and a dye material.

19. The electronic device of claim 18, wherein the liquid crystal material comprise a negative liquid crystal.

20. The electronic device of claim 1, wherein a ratio of a thickness of the first light modulation layer to a pitch of the positive cholesteric liquid crystal is greater than or equal to 5 and less than or equal to 20.
